(19) United States
(12) Patent Application Publication
(10) Pub. No.: US 2004/0100930 A1
(43) Pub. Date: May 27, 2004

(54) WLAN distributed antenna system

(75) Inventors: Yair Shapira, Shoham (IL); Yehuda Holtzman, Mazkeret Batya (IL)

Correspondence Address: DR. MARK FRIEDMAN LTD., C/o Bill Polkinghorn, Discovery Dispatch, 9003 Florin Way, Upper Marlboro, MD, 20772, US

(73) Assignee: FOXCOM WIRELESS

(21) Appl. No.: 10/461,339

(22) Filed: Jun. 16, 2003

Related U.S. Application Data
(60) Provisional application No. 60/428,698, filed on Nov. 25, 2002.

(51) Int. Cl. H04Q 7/24

(52) U.S. Cl. 370/338

(57) ABSTRACT

In a wireless communication system, each of a plurality of passive antennas is operationally connected to one or more WLAN access points via a respective active component, for example a bidirectional amplifier, of a WLAN service combiner. Optionally, for each antenna, a cross-band duplexer in the WLAN service combiner provides an operational connection to cellular services. Alternatively, the antennas are dedicated to the WLAN access point(s). Such a system provides WLAN services in areas of a building using only enough WLAN access points per area to provide adequate capacity.

This is a continuation-in-part of U.S. provisional patent application Ser. No. 60/428,698, filed Nov. 25, 2002.

### FIELD AND BACKGROUND OF THE INVENTION

The present invention relates to wireless local area networks (WLANs) and, more particularly, to an improved WLAN architecture.

Wireless services based on the IEEE 802.11 standard have become widespread. These services are provided in several licensed and unlicensed frequency bands, at various data rates, and in several modulation formats.

WLANs based on the IEEE 802.11 standard extend mobility to high data rate services, such as data sharing, Internet and email. By not being tethered to wired network connections, WLAN users can move about almost without restriction within the coverage area of the WLAN while maintaining mobile access. The goal for providers of WLAN services, for example, property managers, telecommunications managers, or cellular network operators in public areas such as airports, is to create wireless data infrastructures that can grow to support increased capacity needs while minimizing capital costs.

FIG. 1 illustrates the prior art WLAN architecture, based on installation of WLAN access points 10 coupled to the overall network 12, typically by twisted copper wire pairs 14. WLAN access points 10 are active transceivers that require power supply and ongoing inspection and maintenance. Each WLAN access point 10 includes its own passive antenna (not shown) for exchanging RF signals with other suitably configured nearby transceivers.

The number of WLAN access points 10 needed in a given area is determined by coverage requirements: the signal strength must be high enough for adequate reception everywhere in the covered area. An office floor of 20,000 to 30,000 square feet typically needs four WLAN access points 10 to provide adequate coverage. This is true even if the number of users is low enough that a single WLAN access point 10 would provide adequate capacity. To provide adequate coverage in an office building, a WLAN system might include tens or even hundreds of WLAN access points 10 scattered throughout the building, with many of the WLAN access points 10 in hard-to-reach spots such as ceilings and high pillars. This requires a significant investment in installation and maintenance. In addition, to avoid mutual interference, each WLAN access point 10 must operate at its own respective frequency. This mandates strict and costly frequency planning. In addition, when a user moves from the coverage zone of one WLAN access point 10 to the coverage zone of another WLAN access point 10, a resource-consuming, fragile handoff procedure must be executed.

There is thus a widely recognized need for, and it would be highly advantageous to have, a wireless communication system that would allow:

(a) distribution of WLAN signals over a passive coaxial distributed antenna system to allow the installation of WLAN access points 10 in an easily accessible location such as a communications room or a communications closet, while all radiating and receiving elements of the system that are scattered in the covered area are passive elements that do not need power supplies or on-going maintenance;

(b) use of only enough WLAN access points 10 to provide the necessary throughput (e.g., just one WLAN access point 10 supporting four antennas);

(c) sufficient flexibility, either in the initial deployment or later when capacity requirements grow, to add more WLAN access points 10 at a central, easily accessible location; and

(d) coupling of the WLAN signals to a pre-existing passive coaxial cable distributed antenna system.

Kattukaran et al., in WO 03/021995, which is incorporated by reference for all purposes as if fully set forth herein, address these issues by coupling a WLAN access point to the antennas of an existing cellular communication infrastructure, via a coupler in reverse mode. Among the drawbacks of the scheme of Kattukaran et al. are that the reverse mode coupler, as well as the coaxial cables of the cellular communication infrastructure, significantly attenuate the output signals of the WLAN access point and also degrade the reception sensitivity of the WLAN access point, thus decreasing the coverage range of the WLAN access point; and that there is no easy way to add more WLAN access points as required.

### SUMMARY OF THE INVENTION

It is an object of the present invention to provide a WLAN system in which all active elements are located in a centralized, easily accessible location, such as a communication closet, and only passive elements are deployed in the rest of the targeted area.

It is an object of the present invention to optimize the user-to-access-point ratio of a WLAN system.

It is an object of the present invention to optimize the utilization of the available capacity of a WLAN system.

It is an object of the present invention to provide decreased installation costs by using a common set of cables for the delivery of all wireless services.

It is an object of the present invention to allow the implementation of a unified operations and maintenance support system.

Therefore, according to the present invention there is provided a wireless communication system including: (a) at least one WLAN access point; (b) a plurality of passive antennas; and (c) a WLAN service combiner, for operationally connecting the at least one WLAN access point to the passive antennas, the WLAN service combiner including a respective active component for each passive antenna.

Furthermore, according to the present invention there is provided a wireless communication system, including: (a) at least one WLAN access point; and (b) a plurality of passive antennas, operationally connected to the at least one WLAN access point; wherein the passive antennas are dedicated to the at least one WLAN access point.

Furthermore, according to the present invention there is provided a WLAN service combiner, for operationally connecting at least one WLAN access point to a plurality of passive antennas, including: (a) a sufficient number of combiner/splitters to operationally connect the passive antennas to the at least one WLAN access point; and (b) for each passive antenna, a respective active component, the each passive antenna being operationally connected to the at least one WLAN access point via the respective active component and via at least one of the combiner/splitters.

Furthermore, according to the present invention there is provided a method of providing wireless communication services in at least one area of a building, including the steps of: (a) providing each of the at least one area with a respective WLAN access point; (b) providing each of the at least one area with a respective plurality of passive antennas; and (c) in each of the at least one area, operationally connecting the respective WLAN access point to the plurality of passive antennas using a WLAN service combiner that includes, for each antenna of the respective plurality of passive antennas, a respective active component.

Furthermore, according to the present invention there is provided a method of providing wireless communication services in at least one area of a building, including the steps of: (a) providing each of the at least one area with a respective WLAN access point; (b) providing each of the at least one area with a respective plurality of passive antennas; and (c) in each of the at least one area, operationally connecting the respective WLAN access point to the plurality of passive antennas; wherein, in each of the at least one area, the respective plurality of passive antennas is dedicated to the respective WLAN access point.

The wireless communication system of the present invention includes at least one WLAN access point coupled to a plurality of passive antennas by a “WLAN service combiner” that includes, for each antenna, a respective active component such as a bidirectional amplifier. This is in contrast to Kattukaran et al., who use a coupler in reverse mode to isolate their WLAN access point from the cellular base station.

Preferably, each antenna is configured to transmit and receive electromagnetic radiation including frequencies between 2.4 GHz and 2.5 GHz and/or frequencies between 5.15 GHz and 5.85 GHz.

The WLAN service combiner also includes a sufficient number of combiner/splitters to operationally connect the passive antennas to the WLAN access point(s). Optionally, the WLAN service combiner also includes, for each passive antenna, a respective cross-band duplexer that provides an operational connection of cellular services to that passive antenna. Each passive antenna is operationally connected to the WLAN access point(s) via its respective cross-band duplexer. The WLAN service combiner constitutes a separate invention in its own right.

Preferably, the passive antennas are dedicated to the WLAN access point(s), meaning that the passive antennas are used only for wireless LAN and not for other wireless services such as cellular telephony. In fact, the scope of the present invention includes any wireless communication system in which one or more WLAN access points are coupled to a plurality of dedicated passive antennas, even if the coupling is not effected using the WLAN service combiner of the present invention.

The scope of the present invention also includes a method of providing wireless communication services to targeted areas of a building, for example to targeted floors of the building, by providing each target area with a respective WLAN access point and a plurality of passive antennas. In each targeted area, the passive antennas are operationally connected to the WLAN access point using a WLAN service combiner of the present invention. Preferably, only a single WLAN service combiner is provided for each targeted area.

Preferably, in each targeted area, the passive antennas are dedicated to the WLAN access point. In fact, the scope of the present invention includes any method, of providing wireless communication services to targeted areas of a building, in which a WLAN access point is coupled to a plurality of dedicated passive antennas, even if the coupling is not effected using the WLAN service combiner of the present invention.

Preferably, if the passive antennas are not dedicated to the WLAN access point, at least one antenna of each targeted area is operationally connected to cellular services.

### BRIEF DESCRIPTION OF THE DRAWINGS

The invention is herein described, by way of example only, with reference to the accompanying drawings, wherein:

FIG. 1 illustrates a prior art WLAN architecture;

FIG. 2 illustrates the architecture of the present invention;

FIGS. 3-5 are schematic block diagrams of WLAN service combiners of the present invention for operationally connecting, respectively, one, two or four WLAN access points to four passive antennas.

### DESCRIPTION OF THE PREFERRED EMBODIMENTS

The present invention is of a wireless communication system that can be used to provide WLAN services to targeted areas of a building more efficiently than prior art architectures.

The principles and operation of a wireless communication system according to the present invention may be better understood with reference to the drawings and the accompanying description.

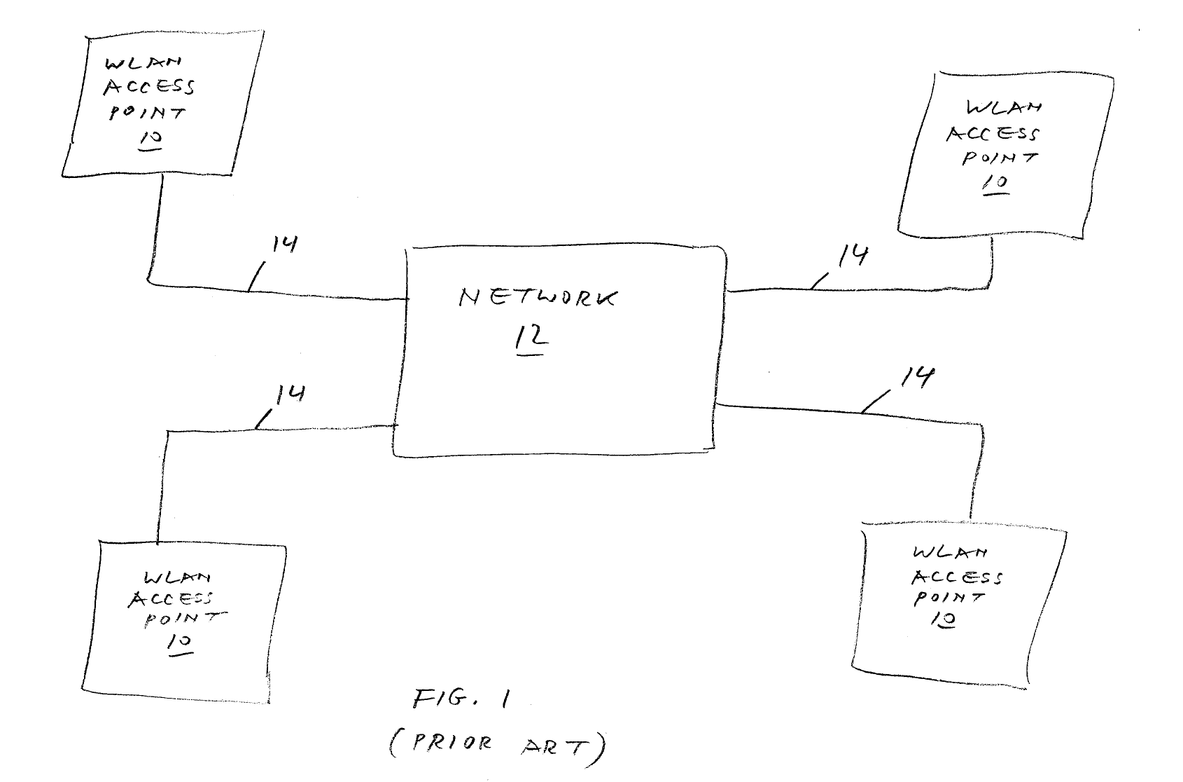

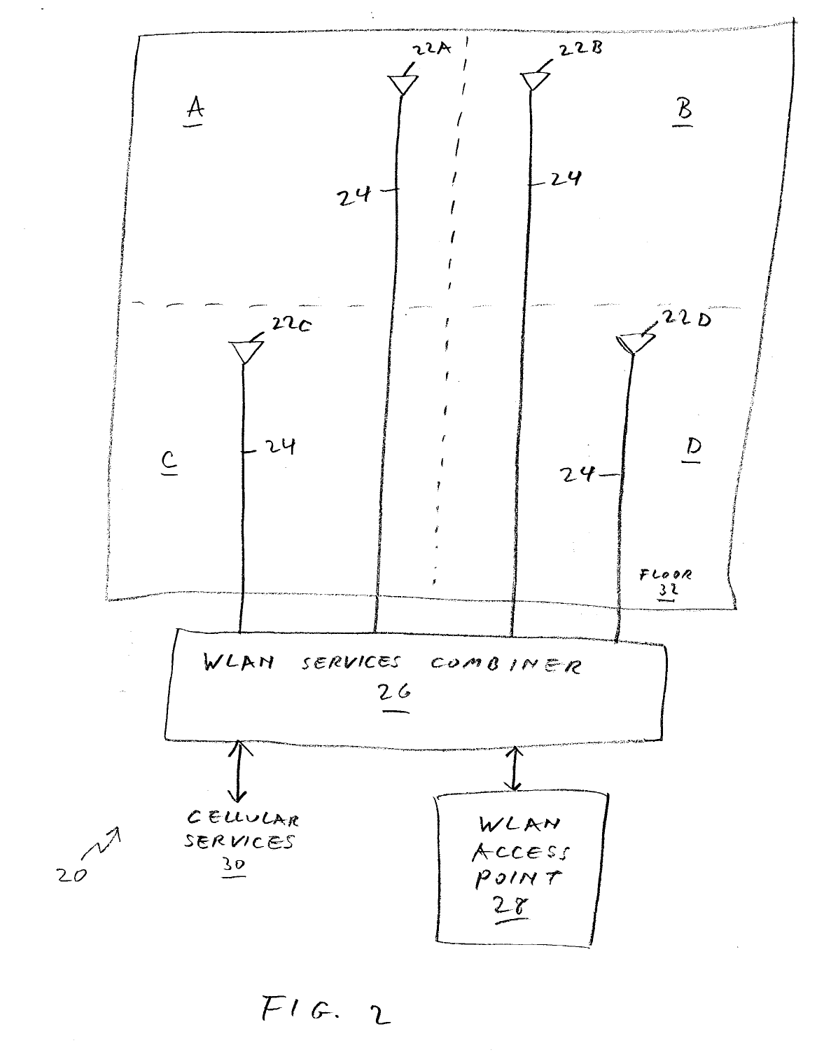

Referring again to the drawings, FIG. 2 is a high level illustration of a wireless communication system 20 of the present invention, installed on a floor 32 of an office building. System 20 substitutes, for WLAN access points 10 of FIG. 1, four passive multi-band antennas 22A, 22B, 22C and 22D. Each antenna 22 provides coverage to a respective targeted coverage area A, B, C or D. The signals to be transmitted are provided by a single WLAN access point 28 via a WLAN service combiner 26 and coaxial cables 24. WLAN service combiner 26 also distributes and provides coverage of cellular services 30. Under the architecture of the present invention, as exemplified in system 20, the number of required WLAN access points 28 is determined by capacity requirements and not by coverage requirements. Often, only one or two WLAN access points 28 are required to provide the capacity requirements of a typical floor area of 20,000 to 30,000 square feet.

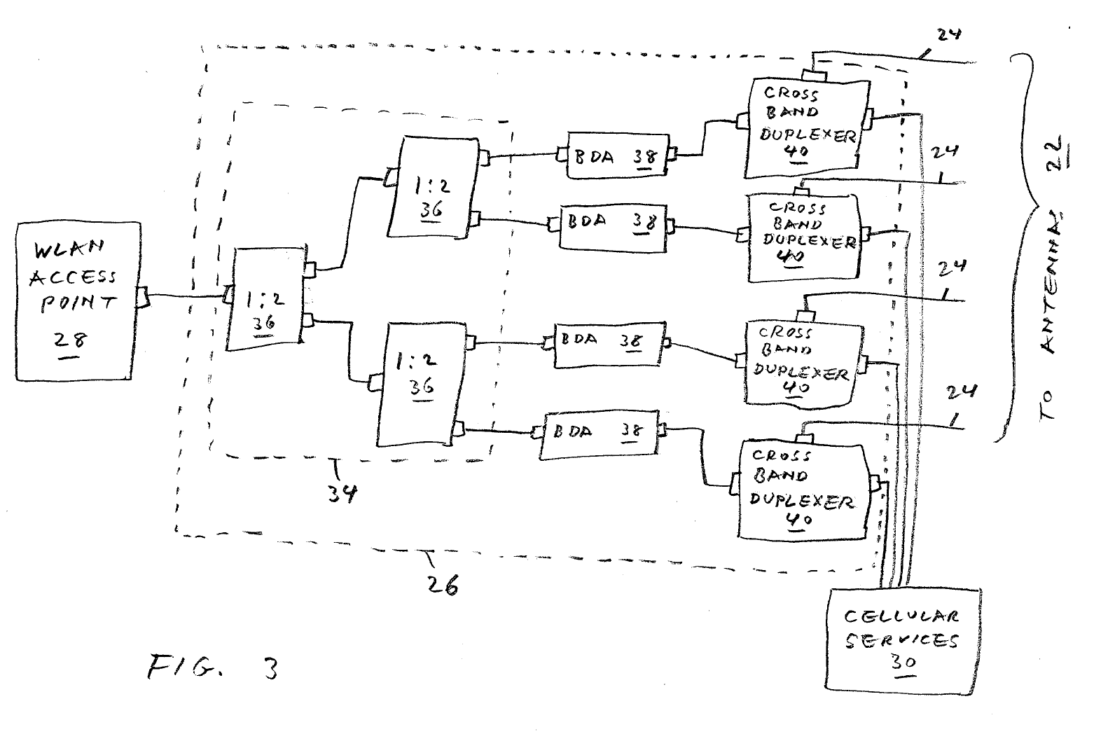

Passive antennas 22 are multiband antennas that are suitable for transmitting and receiving WLAN signals in the 2.4 GHz to 2.5 GHz band and/or the 5.15 GHz to 5.85 GHz band, as well as cellular signals in the 0.8 GHz to 2.2 GHz band. WLAN service combiner 26 includes electronic components that enable the combination of WLAN signals in the 2.4 GHz to 2.5 GHz band and/or the 5.15 GHz to 5.85 GHz band with cellular signals in the 0.8 GHz to 2.2 GHz band. FIG. 3 is a schematic block diagram of WLAN service combiner 26. WLAN access point 28 is fed to a 1:4 combiner/splitter 34 that is realized by three 1:2 combiner/splitters 36. The output of 1:4 combiner/splitter 34 is connected to one of the input ports of each of four cross-band duplexers 40 via four bi-directional amplifiers 38. The other input ports of cross-band duplexers 40 are used to combine cellular services 30. The outputs of cross-band duplexers 40 go to passive antennas 22 via coaxial cables 24.

The distribution and provision of cellular services 30 by WLAN service combiner 26 is optional. Alternatively, passive antennas 22 are dedicated to providing WLAN services via WLAN access point 28. Under that alternative, WLAN service combiner 26 lacks cross-band duplexers 40, and the output of 1:4 combiner/splitter 34 is connected directly to passive antennas 22 via bi-directional amplifiers 38.

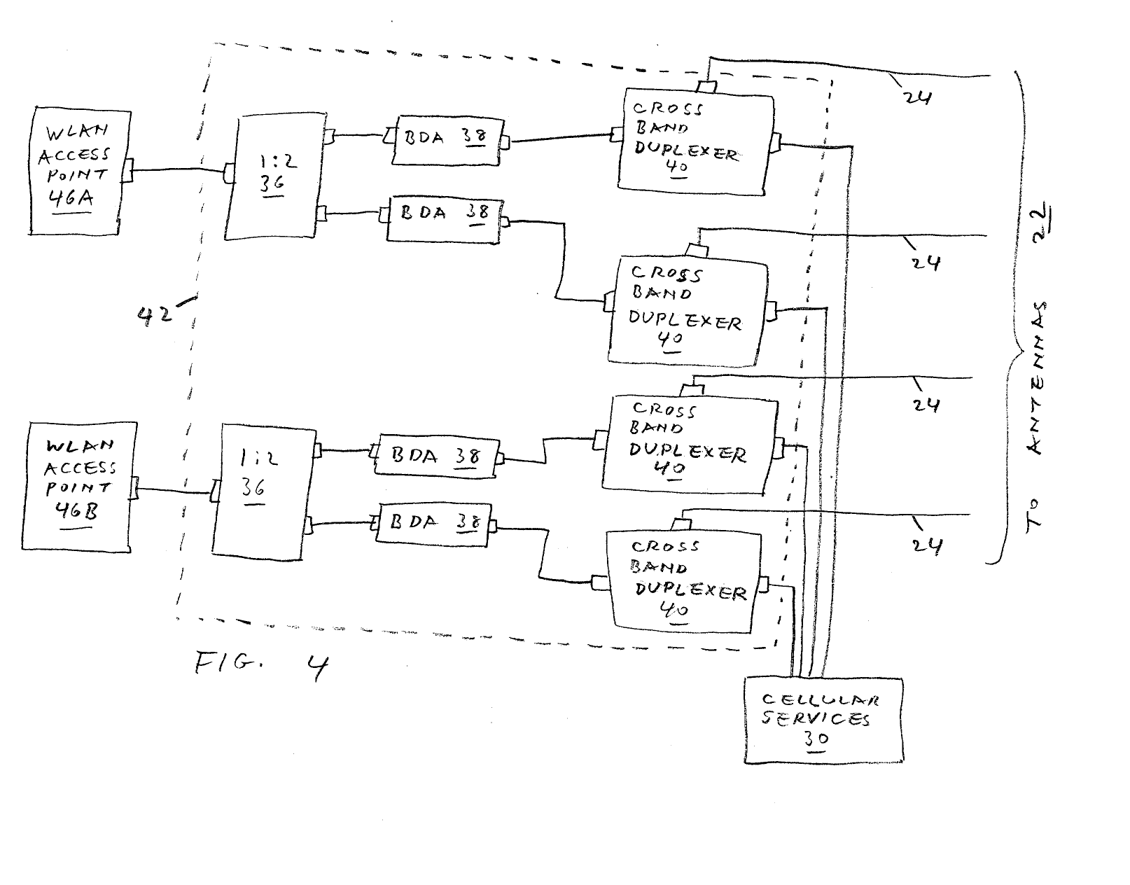

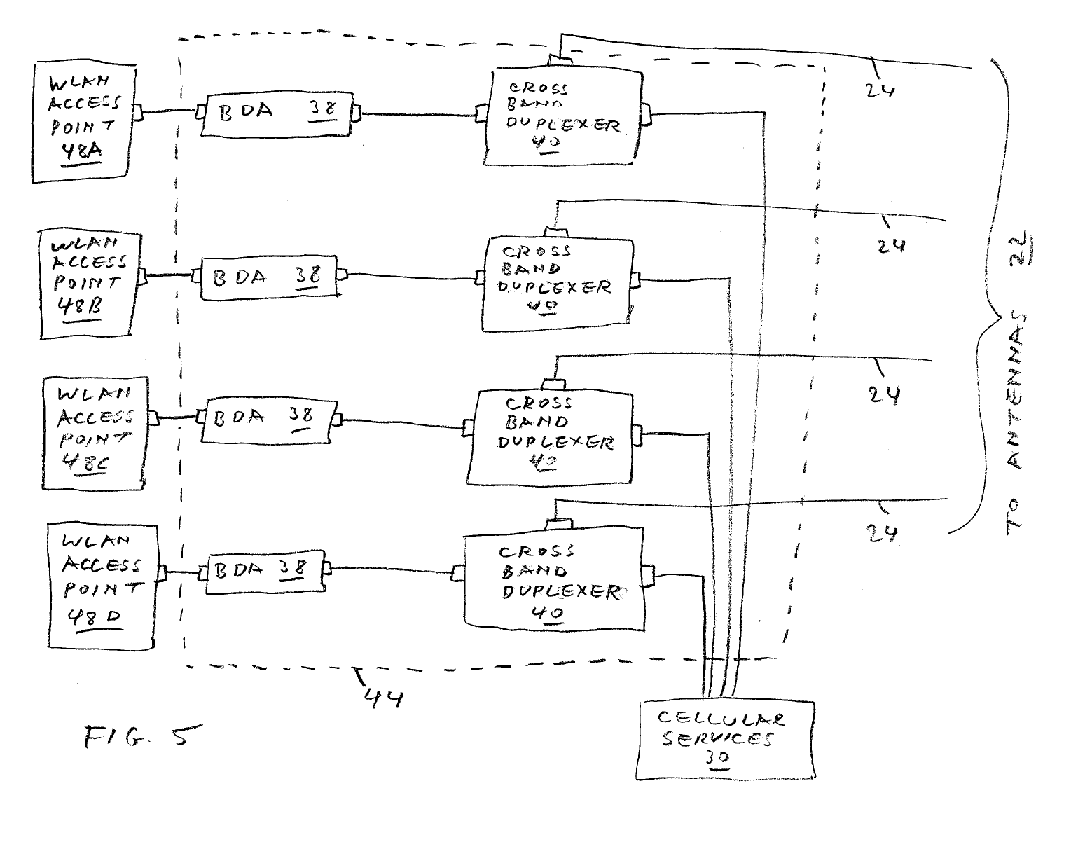

FIG. 4 is a schematic block diagram of a WLAN service combiner 42 that combines the signals of two WLAN access points 46A and 46B with cellular services 30 to feed four passive antennas 22. FIG. 5 is a schematic block diagram of a WLAN service combiner 44 that combines the signals of four WLAN access points 48A, 48B, 48C and 48D with cellular services 30 to feed four passive antennas 22. In FIGS. 3, 4 and 5, like reference numerals refer to like parts.

Typically, the initial installation of a wireless communication system of the present invention on floor 32 is as illustrated in FIGS. 2 and 3, with a single WLAN access point 28. As more capacity is needed, first one additional WLAN access point is installed, as illustrated in FIG. 4, and then two more additional WLAN access points are installed, as illustrated in FIG. 5. Because passive antennas 22 are remote from the WLAN access points in all configurations, the WLAN access points are conveniently housed in one central, easily accessible location on floor 32, for example in a communication closet.

While the invention has been described with respect to a limited number of embodiments, it will be appreciated that many variations, modifications and other applications of the invention may be made.

What is claimed is:

1. A wireless communication system comprising:
(a) at least one WLAN access point;
(b) a plurality of passive antennas; and
(c) a WLAN service combiner, for operationally connecting said at least one WLAN access point to said passive antennas, said WLAN service combiner including a respective active component for each said passive antenna.

2. The wireless communication system of claim 1, wherein said active components are bidirectional amplifiers.

3. The wireless communication system of claim 1, wherein each said passive antenna is configured to transmit and receive electromagnetic radiation including frequencies between 2.4 GHz and 2.5 GHz and frequencies between 5.15 GHz and 5.85 GHz.

4. The wireless communication system of claim 1, wherein each said passive antenna is configured to transmit and receive electromagnetic radiation including frequencies between 2.4 GHz and 2.5 GHz.

5. The wireless communication system of claim 1, wherein each said passive antenna is configured to transmit and receive electromagnetic radiation including frequencies between 5.15 GHz and 5.85 GHz.

6. The wireless communication system of claim 1, wherein said passive antennas are dedicated to said at least one WLAN access point.

7. A wireless communication system, comprising:
(a) at least one WLAN access point; and
(b) a plurality of passive antennas, operationally connected to said at least one WLAN access point;
wherein said passive antennas are dedicated to said at least one WLAN access point.

8. The wireless communication system of claim 7, wherein each said passive antenna is configured to transmit and receive electromagnetic radiation including frequencies between 2.4 GHz and 2.5 GHz and frequencies between 5.15 GHz and 5.85 GHz.

9. The wireless communication system of claim 7, wherein each said passive antenna is configured to transmit and receive electromagnetic radiation including frequencies between 2.4 GHz and 2.5 GHz.

10. The wireless communication system of claim 7, wherein each said passive antenna is configured to transmit and receive electromagnetic radiation including frequencies between 5.15 GHz and 5.85 GHz.

11. A WLAN service combiner, for operationally connecting at least one WLAN access point to a plurality of passive antennas, comprising:
(a) a sufficient number of combiner/splitters to operationally connect the passive antennas to the at least one WLAN access point; and
(b) for each passive antenna, a respective active component, said each passive antenna being operationally connected to the at least one WLAN access point via said respective active component and via at least one of said combiner/splitters.

12. The WLAN service combiner of claim 11, wherein said respective active components are bi-directional amplifiers.

13. The WLAN service combiner of claim 11, further comprising:
(c) for each passive antenna, a respective cross-band duplexer, said each passive antenna being operationally connected to the at least one WLAN access point via said respective cross-band duplexer, said respective cross-band duplexer also providing an operational connection of cellular services to said each passive antenna.

14. A method of providing wireless communication services in at least one area of a building, comprising the steps of:
(a) providing each of the at least one area with a respective WLAN access point;
(b) providing each of the at least one area with a respective plurality of passive antennas; and
(c) in each of the at least one area, operationally connecting said respective WLAN access point to said plurality of passive antennas using a WLAN service combiner that includes, for each antenna of said respective plurality of passive antennas, a respective active component.

15. The method of claim 14, wherein said active components are bidirectional amplifiers.

16. The method of claim 14, wherein a single said respective WLAN service combiner is provided for each of the at least one area.

17. The method of claim 14, wherein, in each of the at least one area, said respective plurality of passive antennas is dedicated to said respective WLAN access point.

18. The method of claim 14, further comprising the step of:
(d) in each of the at least one area, operationally connecting cellular services to at least one antenna of said respective plurality of passive antennas.

19. A method of providing wireless communication services in at least one area of a building, comprising the steps of:
(a) providing each of the at least one area with a respective WLAN access point;
(b) providing each of the at least one area with a respective plurality of passive antennas; and
(c) in each of the at least one area, operationally connecting said respective WLAN access point to said plurality of passive antennas;
wherein, in each of the at least one area, said respective plurality of passive antennas is dedicated to said respective WLAN access point.
